(19) United States
(12) Patent Application Publication
(10) Pub. No.: US 2004/0041847 A1
(43) Pub. Date: Mar. 4, 2004

(54) On-screen scrolling position method

(75) Inventors: Cheng-Shing Lai, Taipei Hsieng (TW); Jian-Ning Ding, Nanking (CN); Sheng-Hong Yang, Nanking (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsien (TW)

(21) Appl. No.: 10/230,228

(22) Filed: Aug. 29, 2002

(51) Int. Cl. G09G 5/00

(52) U.S. Cl. 345/862; 345/786

(57) ABSTRACT

The invention is to provide an on-screen scrolling position method enabling a user to execute the upward or downward scrolling of a data document displayed on the screen of an electronic device, wherein the central processing unit of the said electronic device reads a previously installed cursor from a memory therein based on a signal of a touch-tip stylus continuously contacting the said screen for a certain period of time and displays the said cursor on the said screen, with the data document displayed on the screen scrolled to the corresponding position according to the distance and direction of the said cursor being dragged

### BACKGROUND OF THE INVENTION

1) Field of the Invention

The invention herein relates to user interface navigation, specifically an on-screen scrolling position method.

2) Description of the Prior Art

Mobile telephone design and development in recent years has not only reflected lightweight and compact market trends, but featured significantly advanced built-in capabilities and applications to satisfy consumer demand, with conventional consumer electronic products becoming integrated into multi-function electronic communications products.

Most currently available mobile telephones have networking capabilities that enable users to utilize the said mobile telephones over a network connection for downloading various information. However, the screen surface areas of the said mobile telephones are quite small and have limited data display capability such that when a large website page is browsed, its scrolled position must be continuously shifted upward and downward in order to gradually display the entire contents of the said website page and, as such, users feel that scrolling and reading are rather inconvenient.

### SUMMARY OF THE INVENTION

The primary objective of the invention herein is to provide an on-screen scrolling position method, wherein when the user executes the upward or downward scrolling of a data document displayed on the screen of an electronic device, the central processing unit of the said electronic device reads a previously installed hand-shaped cursor from its memory based on the signal of a touch-tip stylus continuously contacting the said screen for a certain period and displays the said cursor on the said screen, with the data document displayed on the screen scrolled to the corresponding position according to the distance and direction the said cursor was dragged.

Another objective of the invention herein is to provide an on-screen scrolling position method, wherein when the user executes the upward or downward scrolling of a data document displayed on the screen of an electronic device, the central processing unit of the said electronic device is prompted by signals triggered by a specific keys of an inputting device to read a previously installed dialog box from its memory and display the said dialog box on the said screen; commands are then entered into the said dialog box and the data document displayed on the screen is gradually scrolled upward or downward in accordance thereof until the end of the said data document is reached.

### BRIEF DESCRIPTION OF THE DRAWINGS

FIG. 1 is a drawing of a browsed website page displayed on a conventional handheld electronic device.

FIG. 2 is a drawing of the hand-shaped cursor of the invention herein.

FIG. 3 is a drawing of the dialog box of the invention herein.

FIG. 4 is drawing that illustrates the scrolling execution of the invention herein.

FIG. 5 is a flowchart of the operation of the invention herein.

FIG. 6 is a flowchart of another most preferred embodiment of the operation of the invention herein.

### DETAILED DESCRIPTION OF THE INVENTION

The invention herein is an on-screen scrolling position method, wherein when the user executes the upward or downward scrolling of a data document displayed on the screen of an electronic device (such as a mobile telephone or PDA, etc.), the central processing unit of the said electronic device reads a previously installed hand-shaped cursor from its memory based on the signal of a touch-tip stylus continuously contacting the said screen for a certain period and displays the said cursor on the said screen, with the data document displayed on the screen scrolled to the corresponding position according to the distance and direction the said cursor was dragged.

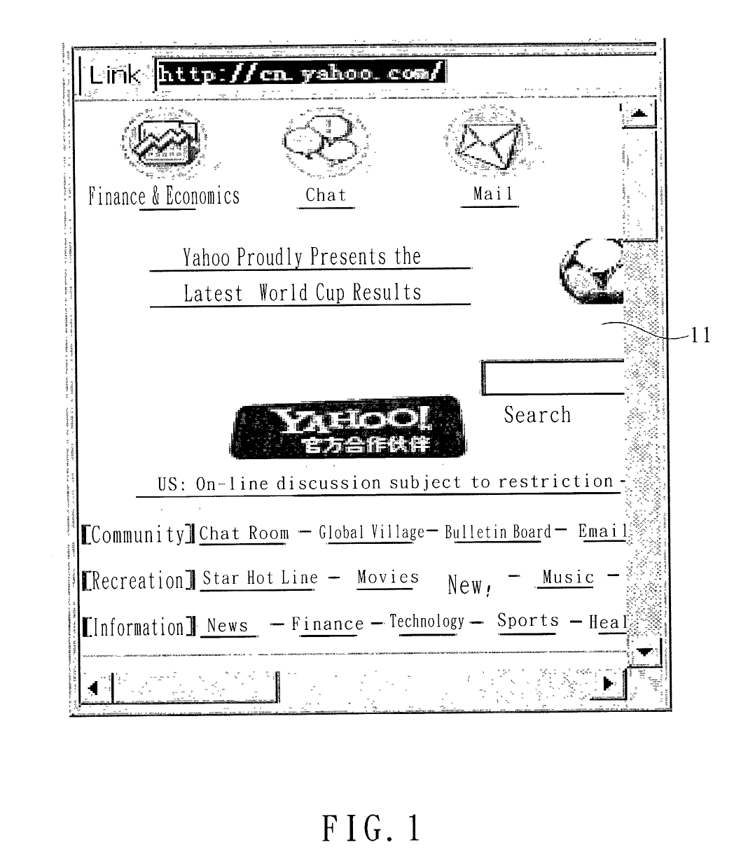

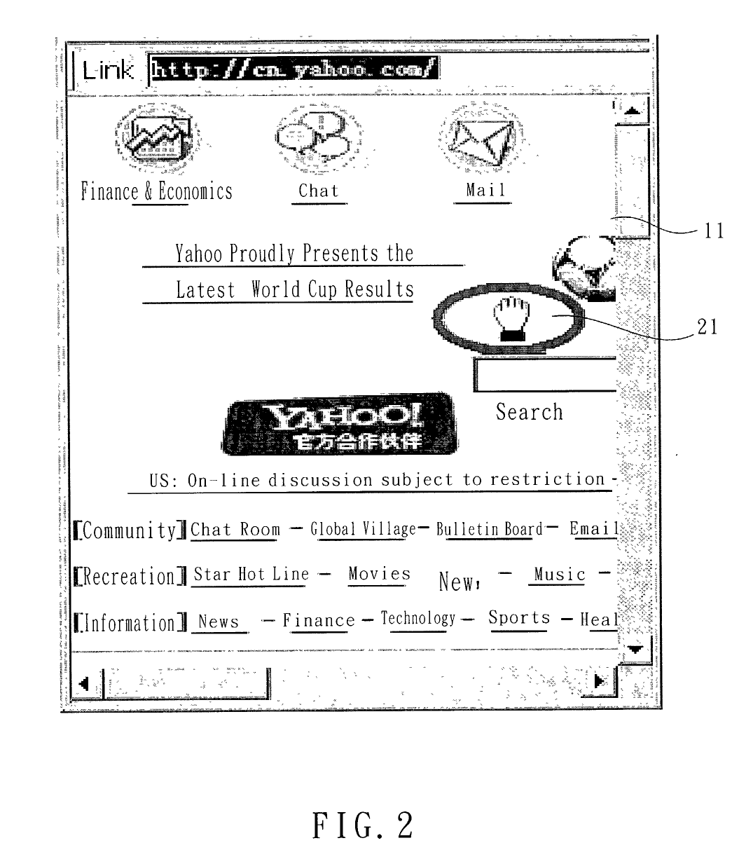

In the embodiment herein, referring to FIG. 1 and FIG. 2, when the user utilizes the said electronic device for connection to a network and the browsing of a website page 11, the continuous contact of the said touch-tip stylus at the same location on the screen of the said electronic device causes the central processing unit of the said electronic device to read a previously installed hand-shaped cursor 21 from its memory based on the signal of the said touch-tip stylus in continuous contact with the screen for a certain period, following which the said screen displays the said hand-shaped cursor 21 at the contacted location and the website page 11 displayed on the screen is scrolled downward to a position corresponding to the distance the said hand-shaped cursor 21 was dragged upward.

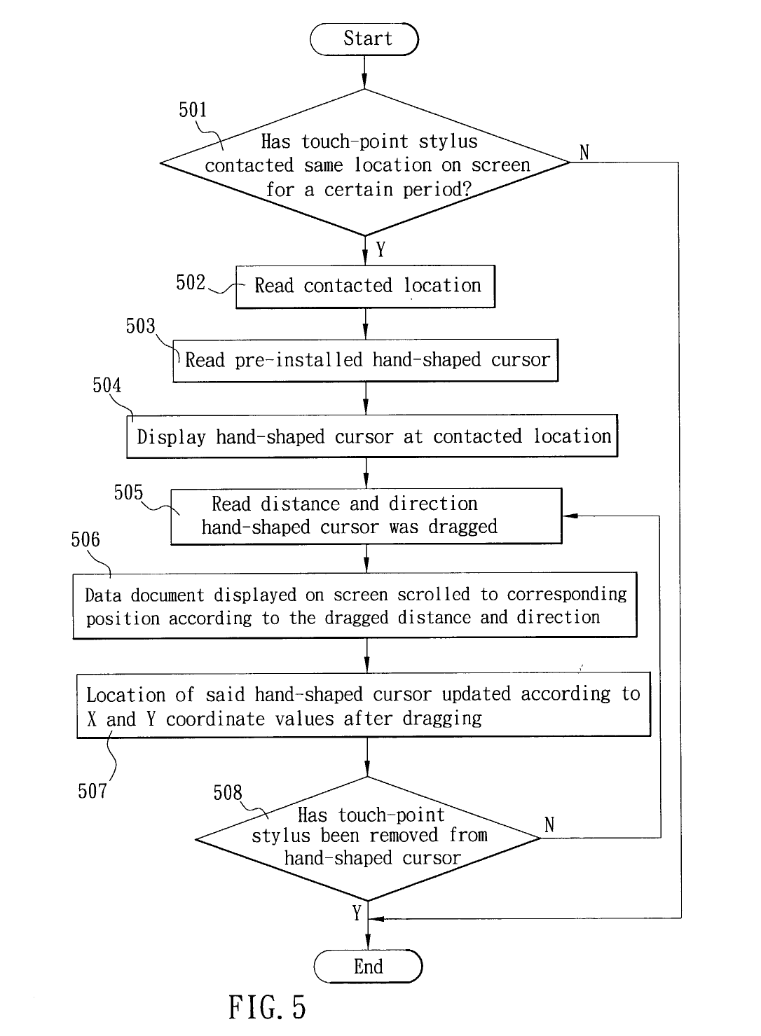

In the embodiment herein, referring to FIG. 5, when the user executes the upward or downward scrolling of a data document displayed on the screen of the said electronic device, the central processing unit of the said electronic device executes the processing of the following procedures:

(501) First, it is determined whether a touch-tip stylus is on the screen and contacting a same location for a certain period. If so, the routine continues on to the execution of the next procedure; otherwise, the routine is ended.

(502) The contacted location (X, Y coordinate values) is read.

(503) Based on the signal of the said touch-tip stylus continuously contacting the screen for a certain period, the previously installed hand-shaped cursor 21 (as indicated in FIG. 2) is read.

(504) The said hand-shaped cursor 21 is displayed on the screen at the contacted location (as indicated in FIG. 2), enabling the user to utilize the touch-tip stylus on the said hand-shaped cursor 21 to execute dragging.

(505) The distance and direction the said hand-shaped cursor 21 was dragged are read.

(506) Based on the distance and direction the said hand-shaped cursor 21 has been dragged, the data document displayed on the screen is scrolled to the corresponding position.

(507) Based on the value of the X and Y coordinates after the said hand-shaped cursor 21 has been dragged, the location of the said hand-shaped cursor 21 is updated to the most recent said X and Y coordinate values.

(508) It is determined whether the touch-tip stylus is no longer contacting the said hand-shaped cursor 21. If so, the routine is ended; otherwise, continue on to step (505).

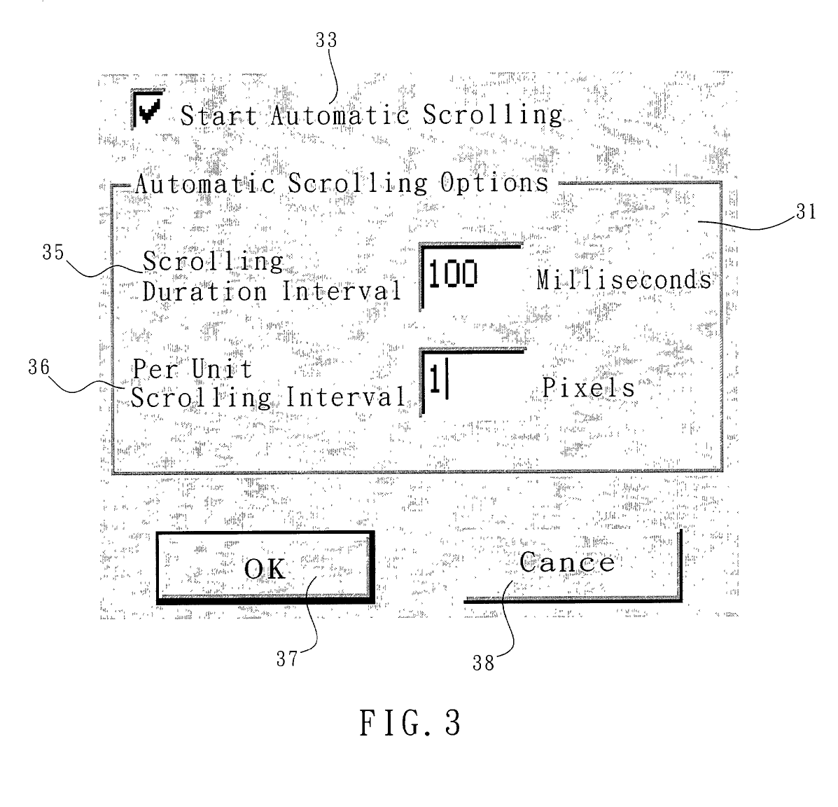

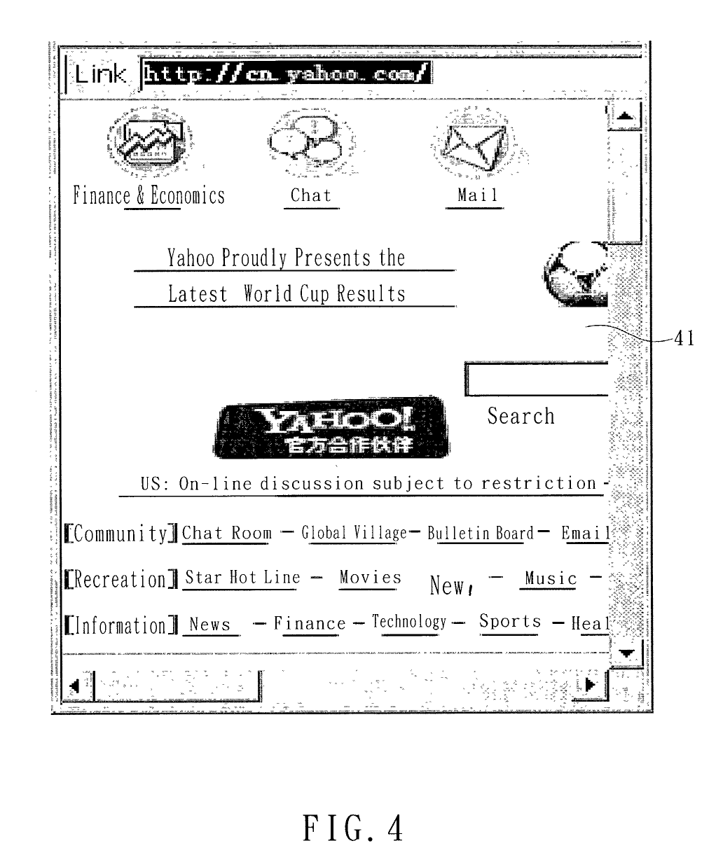

In another most preferred embodiment of the invention herein, referring to FIG. 3 and FIG. 4, when the user executes the upward or downward scrolling of a data document 41 (such as a website page) displayed on the screen of the said electronic device, the central processing unit of the electronic device is prompted by signals triggered by a specific key (such as the up arrow and the down arrow keys) of an inputting device (such as the keyboard of the said electronic device) to read a previously installed dialog box 31 from its memory and display the said dialog box 31 (as indicated in FIG. 3) on the said screen; commands are then entered into the dialog box 31 and the data document 41 displayed on the screen is gradually scrolled upward or downward in accordance thereof until the end of the data document 41 is reached.

In the said embodiment, again referring to FIG. 3, the said dialog box 31 provides a start automatic scrolling option 33, a scrolling duration interval option 35, a per unit scrolling interval option 36, an okay option 37, and a cancel option 38, wherein the units of the said scrolling duration interval option 35 are milliseconds and the units of the said per unit scrolling interval option 36 are pixels, enabling the user to tap select the said start automatic scrolling option 33, fill in the desired scrolling duration and interval of the said scrolling duration interval option 35 and the per unit scrolling interval option 36 via a keyboard input method, and then tap select the okay option 37 such that commands entered in the said dialog box 31 prompt the said central processing unit of the said electronic device to display the data document 41 on the screen and gradually scroll it upward or downward accordingly until the end of the said data document 41 is reached; if automatic scrolling is not desired, then the cancel option 38 is tap selected.

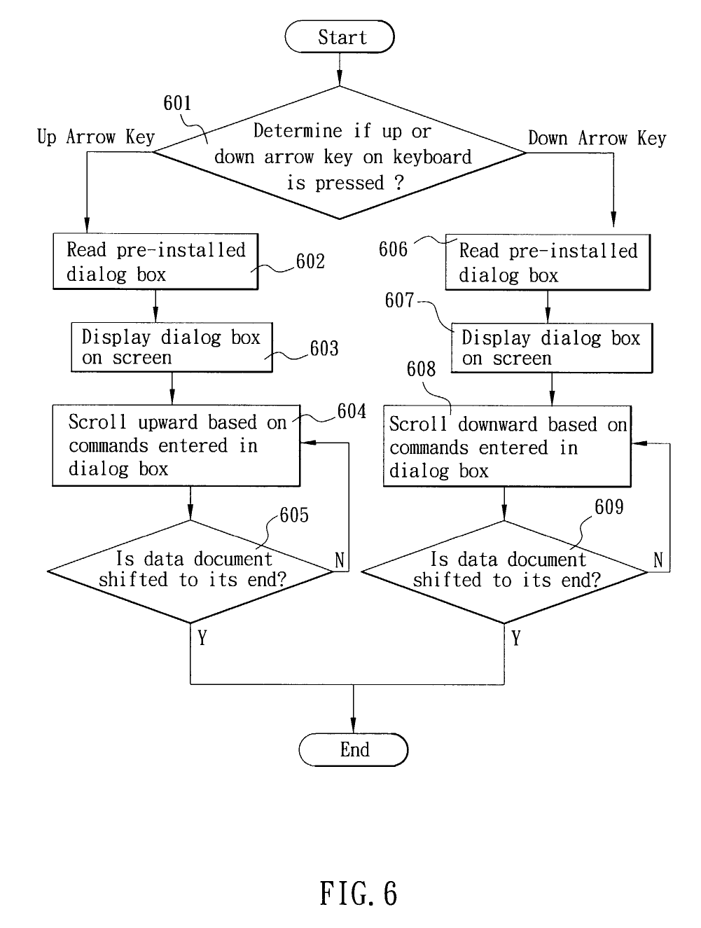

In the said embodiment, referring to FIG. 6, when the user executes the upward or downward scrolling of a data document 41 displayed on the screen of the said electronic device, the central processing unit of the said electronic device executes the processing of the following procedures:

(601) First, it is determined whether an up arrow key or down arrow key on the keyboard has been pressed. If an up arrow key is pressed, then step (602) is executed; if a down arrow key is pressed, then step (606) is executed.

(602) Based on the signal of the said up arrow key that was pressed, the previously set dialog box 31 (as indicated in FIG. 3) is read from the memory of the said electronic device.

(603) The said dialog box 31 is displayed on the screen to provide for user tap selection.

(604) Based on the commands entered in the said dialog box 31, the scrolled position of the said data document 41 is gradually shifted upward until the end of the said data document 41 is reached.

(605) A determination is made as to whether the scrolled position of the said data document 41 has been shifted to the end of the said data document 41. If so, the routine is ended; if not, the routine continues on to step (604).

(606) Based on the signal of the said down arrow key that was pressed, the previously set dialog box 31 (as indicated in FIG. 3) is read from the memory of the said electronic device.

(607) The said dialog box 31 is displayed on the screen to provide for user tap selection.

(608) Based on the commands entered in the said dialog box 31, the scrolled position of the said data document 41 is gradually shifted upward until the end of the said data document 41 is reached.

(609) A determination is made as to whether the scrolled position of the said data document 41 has been shifted to the end of the said data document 41. If so, the routine is ended; if not, the routine continues on to step (608).

Since the screen surface area of a conventional hand set is quite small and the screen of the said hand set is incapable of displaying an entire website page in a single instance when the said hand set is utilized to browse a website page over a network connection, the user can only repeatedly press the up arrow and down arrow keys on its keyboard to shift the scrolled position and thereby gradually display the said website page for reading. However, the method of the invention herein, enables the scrolled position of said website page to be efficiently shifted by dragging the hand-shaped cursor 21 or through automatic scrolling. As such, this eliminates the need to repeatedly press the up arrow and down arrow keys on the keyboard to read data documents displayed on the screen of a conventional hand set.

1. An on-screen scrolling position method in which, when the position of a data document displayed on a screen of an electronic device being scrolled, the central processing unit of the said electronic device executes the processing of the following procedures:
first, determining whether the said screen being touched by a touch-tip stylus on a same location for a certain period of time; if so, continuing on to the execution of the next procedure;
reading the contacted location;
reading a previously installed cursor from a memory installed in the said electronic device based on a signal of the said touch-tip stylus continuously contacting the said screen for a certain period;
displaying the said cursor on the said screen at the contacted location;
reading the distance and direction of the said cursor being dragged;
scrolling the said data document displayed on the screen to a corresponding position based on the distance and direction of the said cursor being dragged.

2. An on-screen scrolling position method as claimed in claim 1 in which the said electronic device can be a mobile telephone.

3. An on-screen scrolling position method as claimed in claim 1 in which the said data document can be a website page.

4. An on-screen scrolling position method in which when the position of a data document displayed on a screen of an electronic device being scrolled, the central processing unit of the said electronic device executes the processing of the following procedures:
first, reading a previously installed dialog box from a memory installed in the said electronic device based on a signal triggered by a specific key of an inputting device installed on the said electronic device;
displaying the said dialog box on the said screen;
gradually shifting the scrolled position of the said data document on the said screen upward or downward based on the commands entered in the said dialog box until reaching the end of the said data document.

5. An on-screen scrolling position method as claimed in claim 4 in which the said dialog box provides a start automatic scrolling option, a scrolling duration interval option, a per unit scrolling interval option, an okay option, and a cancel option, wherein the units of the said scrolling duration interval option are milliseconds and the units of the said per unit scrolling interval option are pixels, which enables the said central processing unit of the said electronic device to display the said data document on the screen and gradually scroll the said data document upward or downward, based on the options entered in the said dialog box, until the end of the said data document is reached.

6. An on-screen scrolling position method as claimed in claim 4 in which the said inputting device is a keyboard.

7. An on-screen scrolling position method as claimed in claim 4 in which the said electronic device can be a mobile telephone.

8. An on-screen scrolling position method as claimed in claim 4 in which the said data document can be a website page.

9. An on-screen scrolling position method as claimed in claim 6 in which the specific key of the said keyboard can be the up arrow key.

10. An on-screen scrolling position method as claimed in claim 6 in which the specific key of the said keyboard can be the down arrow key.
